(19) United States
(12) Patent Application Publication
(10) Pub. No.: US 2002/0013907 A1
(43) Pub. Date: Jan. 31, 2002

(54) Method of preventing stack manipulation attacks during function calls

(76) Inventor: Christian May, Munchen (DE)

Correspondence Address: LERNER AND GREENBERG, P.A., Post Office Box 2480, Hollywood, FL, 33022-2480, US

(21) Appl. No.: 09/829,299

(22) Filed: Apr. 9, 2001

Related U.S. Application Data
(63) Continuation of application No. PCT/DE99/03226, filed on Oct. 6, 1999.

(30) Foreign Application Priority Data
Oct. 9, 1998 (DE) 198 46 673.0

(51) Int. Cl. G06F 12/14

(52) U.S. Cl. 713/200

(57) ABSTRACT

A hardware-supported method of preventing stack manipulation attacks during function calls. In the event of a call of an unsafe function, stack access is restricted by hardware to the stack area of this function.

### CROSS-REFERENCE TO RELATED APPLICATION

This application is a continuation of copending International Application No. PCT/DE99/03226, filed Oct. 6, 1999, which designated the United States.

### BACKGROUND OF THE INVENTION

FIELD OF THE INVENTION

Mutually dependent software modules of different manufacturers are to be installed on future chip cards or smart cards. Different modules of different manufacturers have at the same time different access rights to resources of the chip card. For example, only the operating system has access to certain memory areas in the NVRAM, which must not be manipulated by other modules.

Such an access restriction for the protection of the working memory areas of individual programs against access with an altering effect by other programs running on the chip card is described for example in U.S. Pat. No. 5,754,762. Although the method described there ensures that a program that is active on the chip card cannot manipulate any working memory areas of other programs, there is a further possibility of attack by altering not the working memory but the stack with the respective return addresses of the subroutines. Such a manipulation attack on the stack of the processor cannot be averted by the method described in U.S. Pat. No. 5,754,762.

This is because, for reasons of memory efficiency and performance, the stacks of a called function and a calling function are physically one behind the other in the same memory area. Since the possibility of a library function on a high security level calling a function of an application with a low security level cannot conceptually be ruled out, one possible attack scenario is that, by accessing the program stack, the called function of the application manipulates the data area of the library function on the stack.

On chip card controllers, there has so far not been any solution in the prior art. The problem has not arisen before, because previously one manufacturer was responsible for the entire software.

In modern processors, use is made for example of a Page Table or Segment Descriptor Table (MMU), into which the multitasking operating system enters the memory area that is valid for the application. The process communication and monitoring is thereby carried out by the operating system.

In the case of chip cards or smart cards, function calls between functions on different security levels do not go via the operating system but are executed directly, for performance reasons.

### SUMMARY OF THE INVENTION

The object of the present invention is to provide a method for preventing stack manipulation attacks in function calls which overcomes the above-noted deficiencies and disadvantages of the prior art devices and methods of this general kind, and which prevents the direct and indirect manipulation of the stack area, as functions assessed as safe, by functions that are assessed as unsafe.

With the above and other objects in view there is provided, in accordance with the invention, a method of preventing stack manipulation attacks during function calls. According to the invention, in an event of a call of an unsafe function defined in a given stack area, restricting stack access by hardware to the given stack area of the unsafe function.

In other words, according to the invention, if an unsafe function is called, stack access is restricted by hardware to the stack area of that function. In other words, stack access is restricted by storing a reference to a stack frame of a calling function before the call of the unsafe function.

It is particularly preferred here, for restricting stack access, to store the reference to the stack frame of the calling function before the call of the unsafe function. Furthermore, it is preferred here to provide a mechanism preventing the called function from being able to alter the value of the reference to the stack frame. Furthermore, it is preferred to ensure by a protective mechanism that the stack pointer does not go beyond the valid stack area of the current function.

In accordance with another feature of the invention, a mechanism is provided for preventing the called function from being able to access the value of the reference, the stack frame, and all data lying before that stack frame.

In accordance with a further feature of the invention, a protective mechanism is provided to ensure that the stack pointer does not go beyond the valid stack area of the called function.

In accordance with a particularly preferred feature, the stack is restored to the original state upon returning from the unsafe function.

In accordance with a concomitant feature of the invention, in an event of a function call, a memory area is initially reserved on the stack for function data to be protected, and optionally thereafter the function arguments are placed on the stack, and the reference, lying in the protected area, to the stack frame of the calling function is placed on the previously reserved area of the stack, and the reference to the stack frame of the called function is written into the protected area.

In other words, this method which is most favorable according to the invention proceeds in the event of a function call by initially reserving on the stack a memory area for function data to be protected and optionally placing the function arguments behind that on the stack, and placing the reference, lying in the protected area, to the stack frame of the calling function on the previously reserved area of the stack and writing the reference to the stack frame of the called function into the protected area.

Other features which are considered as characteristic for the invention are set forth in the appended claims.

Although the invention is illustrated and described herein as embodied in a method of preventing stack manipulation attacks during function calls, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block diagram showing the assignment of the stack and the associated registers before and after the function call; and

FIG. 2 is a schematic block diagram showing the sequence of the calls in the case of a safeguarded function call.

### DESCRIPTION OF THE PREFERRED EMBODIMENTS

Previously, a single chip card manufacturer supplied both the operating system of the chip card and the application programs (it is noted, in this context, that the terms chip card and smart card are used interchangeably in this text). The operating system of the chip card could therefore be regarded as part of the application program. The chip card operating system and the application programs were supplied on specially manufactured masks for the ROM (read-only memory) of the chip card ICs. Consequently, previously we were concerned with solutions in which the programs were defined by hardware, that is to say were hard-wired.

By contrast, the present invention is concerned with a situation in which different manufacturers can supply libraries and application programs, which then have to coexist on a card. For security reasons, the program architecture of the chip card must then make it possible for the operating system and the libraries to be protected against manipulations of their own “private” data, program code and stack by a running program. In the case of one exemplary embodiment of the invention, this can be achieved by various measures:

I. Segmented Addressing:

The physical address space of 2²⁴ bits is made accessible via a maximum of 256 data segments and 255 program segments. The length of the physical address space which can be addressed by one segment may lie between 4 bytes and 2¹⁶ bytes. A segment is defined by its length and its physical starting address. The address (pointer) of a memory location then comprises 8 bits, which represent the address of the segment, and an offset of 16 bits. This forms the direct address.

II. Memory Management Unit (MMU):

A Memory Management Unit (MMU) keeps a list of all the segments required by the running program. Each of these segments has additional attributes in the MMU, such as its property as a “program segment” or “data segment”, the identification of the program to which it belongs, and the confidence class. Different programs which are running at the same time are distinguished by different program identifications. Program counters and data addresses always relate to segment entries in the MMU with the same program identification. Furthermore, the segment of the program counter refers to an entry in the MMU with the same segment identification and the attribute “program segment”. On the other hand, all the data addresses in the MMU registration list can be found via the same program identification and the attribute “data segment”.

III. Confidence Classes:

When a manufacturer is writing a program A which accesses another program B of another manufacturer, the first manufacturer automatically has confidence in the code of the second manufacturer. Otherwise, they would not have accessed this program. On the other hand, the manufacturers of the program B do not necessarily know anything about the program A. Therefore, they must protect their program code, the stack content and the data against harmful manipulations by program A. This must be ensured in particular because the library B can also be used by other application programs, which rely on the library B functioning correctly. According to the invention, this protection is supported by four confidence classes (0 to 3), which represent additional attributes of the segment entries in the MMU. A program section on a lower confidence class enjoys greater confidence than another program section with a higher confidence class. Consequently, device drivers may lie on a segment with the confidence class 0, the card operating system on segments with a confidence class 1, libraries on confidence class 2, and applications on confidence class 3. The confidence classes play an important part in the setting up of rules for function calls between segments (remote calls), and in data access.

IV. Function Portals:

Only functions which have been produced by the same manufacturer of a library or application are packed in a segment. Therefore, a segment does not need to provide any protective measures for function calls within the segment (local calls). On the other hand, remote calls are potentially dangerous. An application program must not be allowed to jump to a program code section of the card operating system at any desired entry address. This is because if this is not prevented, unpredictable events may occur. The solution currently preferred is to define addresses for remote calls not as function entry addresses but as function portals. A segment may have a maximum of 255 such portals. If a remote call takes place, the portal address comprises a word of two bytes in length: the higher-order byte contains the segment identification and the lower byte the portal of the function to be jumped to. The remote call reads the word automatically with the offset, defined under 2, of the corresponding segment and interprets it as a function entry address. Nevertheless, the return from a remote function call is possibly dangerous, because the return address represents a direct address on the stack, which may have been altered by the called function. Therefore, usually only remote calls from higher confidence classes to lower confidence classes are allowed. Conversely, only remote returns from lower confidence classes to higher confidence classes are admissible. An exception is the remote calls from the confidence classes 0 or 1, which are discussed below.

Although the function calls will usually be function calls within the segment or function calls on the same or a lower confidence class, it would be too restrictive to prohibit remote calls from higher to lower confidence classes completely: the card operating system must be capable of starting an application program. The protocol for loading application programs may also require call-backs, in the case of which a function pointer of a function A on a higher confidence class is transferred to a function B on a lower confidence class and function B then calls function A. Calls from lower to higher confidence classes are referred to hereafter as “call-backs” for short. Similarly, the Virtual Java Machine (JVM) requires such call-backs in order to start a Java card. In principle, any remote call is allowed, remote returns are prohibited from a higher confidence class into a lower confidence class. Since remote calls from the card operating system to an application program or a library are also inherently unsafe, the card operating system must provide a special mechanism to carry out safe call-backs. For this purpose, a card operating system function INT-SAVE-CALL (FUNC, ARG1, ARG2 . . . ) is defined and must be called up to carry out a call-back. The object of SAVE-CALL is to protect the data on the stack, including the call-back vector to the function which has called SAVE-CALL but with the exception of the values of FUNC, ARG1, ARG2 . . . , from read and write accesses within the function FUNC.

In principle, there are three solutions for SAVE-CALL:

A. SAVE-CALL opens a new stack segment; the card operating system manages the stack access;

B. SAVE-CALL restricts the write and read access to the current stack segment.

Here again there are two possibilities, to be specific:

a. The card operating system manages the stack access.

b. The remote-call and remote-return instructions manage the stack access.

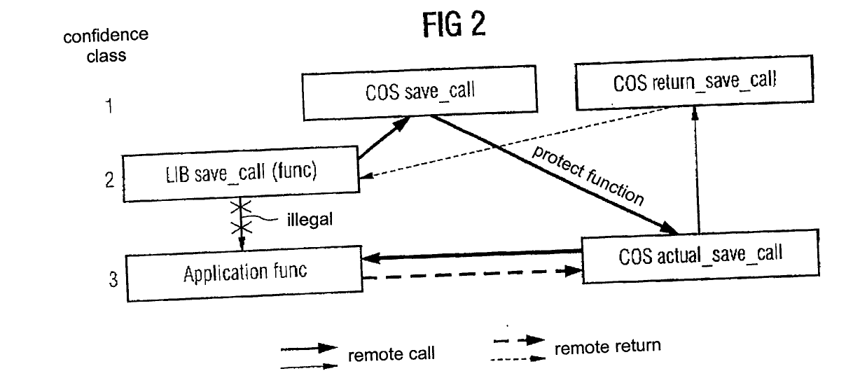

Referring now to FIG. 2, there is shown the execution of a safe return to a function FUNC ( ) in confidence class 3 by a caller in confidence class 2. FUNC and its parameters are transferred as parameters to an operating system function SAVE-CALL. SAVE-CALL transfers FUNC and its arguments on to an operating system function ACTUAL SAVE CALL in confidence class 3. This return is only admissible because SAVE-CALL is in confidence class 1. ACTUAL SAVE CALL already has a protected stack when it calls FUNC. Once FUNC has returned to ACTUAL SAVE CALL, RETURN SAVE CALL on the card operating system with confidence class 1 is called. RETURN SAVE CALL releases the stack and replaces its return vector by the return vector of SAVE CALL, which has been stored in a file of the card operating system by SAVE CALL itself. Then, RETURN SAVE CALL returns to the calling function in the library LIB.

According to the invention, there are two different possibilities for realizing the function SAVE CALL:

First, SAVE CALL opens a new stack or a new stack segment.

When SAVE CALL is called, this function takes over the stack with the following contents:

Operands, arguments, the name of the function FUNC and the return address to the calling program in LIB.

The program SAVE CALL then executes the following actions: a new data segment DS is opened, the arguments and the name of the function FUNC are copied into the new data segment, the current return address for the remote return SP with a length of 24 bits is stored into a file of the card operating system, SP is set to DS:LENGTH and the function ACTUAL SAVE CALL is called.

The function ACTUAL SAVE CALL therefore takes over the following stack content before the function FUNC is called:

Arguments, name of the function FUNC, return address to the program SAVE CALL.

The program ACTUAL SAVE CALL then carries out the following actions:

Fetch the return vector from the stack, load the address of FUNC into the accumulator, call the function FUNC indirectly.

Once the function FUNC has been executed, the stack of ACTUAL SAVE CALL is empty. Then the function RETURN SAVE CALL is called. This loads the register for the remote return address SP with the original values, which have been buffer-stored in a card operating system file, and clears the stack or stack segment created in the meantime. The function RETURN SAVE CALL then transfers the stack with the initial assignment of operands, arguments, the name of the function FUNC and the return vector to the calling program in LIB. This return address is then loaded into the accumulator and the program sequence consequently returns to the calling program. This procedure has the advantage that it can be used for all conceivable structures of the stack. However, the arguments of FUNC must be copied and a card operating system file for the buffer storage of the return address must be created.

Second, a further solution according to the invention for safe return calls introduces a write/read barrier on the stack, which protects the return vector to the calling program against alterations and similarly protects the entire stack content of the calling program against write and read accesses. This can be achieved by a suitable reduction in the length of the stack segment or by an additional register in the Memory Management Unit (MMU). One problem which has to be solved in this case is that the arguments of a function lie before the return vector if the conventional C stack layout has been used. A solution to this is obtained by re-ordering the C stack in such a way that space for the return vector must be reserved before the arguments are placed on the stack. This leads to additional programming effort for a function call in comparison with the customary stack layout.

This further method sequence according to the invention proceeds specifically as follows:

The stack is transferred to SAVE CALL. SAVE CALL sets a read and write barrier between the return vector and the parameters of SAVE CALL. The stack then has the following structure:

Operands, return vector to the calling program in LIB, return read and write barrier, arguments, name of the function FUNC. Then the program ACTUAL SAVE CALL is called. Seen from the program ACTUAL SAVE CALL, the stack content consequently comprises only the arguments and the name of the function FUNC before the function FUNC is called, since the function ACTUAL SAVE CALL cannot be read out over the read and write barrier.

Then, to execute the function FUNC, the return vector is fetched from the stack, the address of the function FUNC is loaded into the accumulator and the function FUNC is called indirectly.

On returning from the function FUNC, the stack for the function ACTUAL SAVE CALL is empty. The function ACTUAL SAVE CALL than calls the function RETURN SAVE CALL. The function RETURN SAVE CALL clears or removes the read and write barrier for the stack, so that the stack for the function RETURN SAVE CALL again has the following content:

Operands, return vector to the calling program in LIB, return vector to ACTUAL SAVE CALL. From the program RETURN SAVE CALL, the return vector to the program ACTUAL SAVE CALL is then fetched from the stack and the stack frame pointers are reset. The program ACTUAL SAVE CALL then transfers control to the calling program in LIB.

It should be noted here that this procedure is possible only with a special structure of the stack. This procedure has the advantage, however, that the arguments of FUNC do not have to be copied, and no additional files have to be created by the operating system.

Furthermore, the solution that a certain number of arguments are transferred into registers is also conceivable according to the invention. A safe return call would then allow only this number of arguments as a maximum. The return vector of a safe return call then comprises the return vector of a normal function call and additionally the length of the old stack segment.

Furthermore, it would also be possible according to the invention to buffer store the return vector on a separate stack. The read and write barrier can then be easily installed before the first function argument is placed on the normal stack.

Also conceivable is a solution according to the invention in which the same stack structure as in the above second solution is used. By contrast with the first two solutions, however, it is not the card operating system but the calling program itself that protects the stack of the calling program against read and write access by a special command SEC CALL. During the execution of the return command, it must then be checked whether the return vector lies behind the read and write barrier. If this is the case, the old read and write barrier, which has been stored on the stack behind the current barrier, can be re-established and the customary return can be executed. Otherwise, only the customary return is executed. With regard to the structure of the stack, this solution corresponds to the previously described solution with the special stack structure.

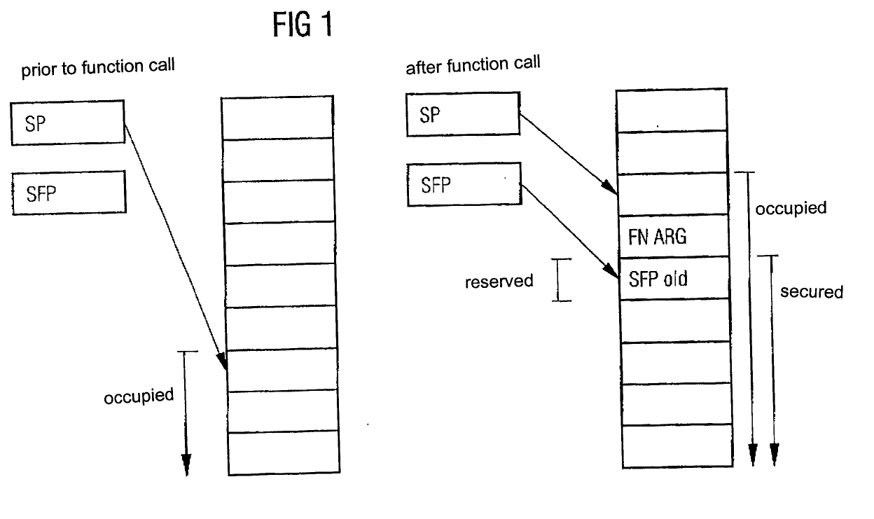

FIG. 1 shows the simplest basic principle of all these solutions according to the invention:

In the event of a call of an unsafe function, stack access must be restricted by hardware to the stack area of said function. This is achieved by storing the stack frame pointer of the calling function. In this case, a protective mechanism must be implemented, so that the called function cannot alter the value of the stored stack frame pointer. Furthermore, when writing to the stack, it must be ensured that the stack pointer does not go beyond the valid stack area of the current function.

The protective mechanism can be activated automatically or triggered by the calling function directly.

On RETURN from the unsafe function, the stack is in this case restored to the original state by implementation of hardware.

The left-hand representation in FIG. 1 correspondingly shows the state before the function call. The stack pointer SP is pointing at the uppermost assigned memory cell in the stack. Below this, the stack is assigned, but access to the stack is allowed. The stack frame pointer SFP is not assigned or contains a value for a barrier from an earlier call.

The right-hand representation of FIG. 1 shows the state after the function call. The stack pointer now points at a memory cell further up, which is the last that is assigned. After this or these assigned memory cells, there finally lies the called function FN and its arguments (ARG). The frame pointer is pointing at a field in which the old value of the stack frame pointer is buffer-stored (in the case of multiple protected function calls), or which is empty. The memory cell to which the stack frame pointer is pointing is automatically blocked for access, since accesses are only permissible if SP <SFP. Consequently, this memory cell and all the cells following below it are also safeguarded against manipulations.

In the event of a function call, initially a memory area for function data to be protected is reserved on the stack (return address, etc.). Subsequently, the function arguments are placed on the stack. Finally, during the function call, the SFP lying in the protected memory area (with the stack frame pointer of the calling function of the current function) is placed on the previously reserved area of the stack and the stack frame pointer of the current function is written into the protected area (SFP). This takes place either by an operating system call or by a hardware mechanism.

In the event of stack manipulations, the stack pointer is always compared with the stored value SFP in the protected area, to prevent the stack area of the calling function from being able to be manipulated.

Consequently, according to the invention this is a hardware-supported solution for safeguarding the stack of the calling function against overwriting. The return to the safe function, and optionally also the call of the unsafe function, can thereby take place without interaction with the operating system. This means a speed advantage in the case of unsafe function calls.

The alternative would be not to execute the function call directly but to transfer the function pointer and the arguments of the function to the operating system, which would safeguard the previous stack and subsequently call the function. However, this is very complicated and time-consuming in terms of computing time.

Consequently, the present invention significantly facilitates the implementation of a safe call-back in C and for the Java Virtual Machine on a chip card. Among other things, it is possible to do without the detour via the operating system, which usually represents a great handicap.

I claim:

1. A method of preventing stack manipulation attacks during function calls, which comprises, in an event of a call of an unsafe function defined in a given stack area, restricting stack access by hardware to the given stack area of the unsafe function.

2. The method according to claim 1, wherein the step of restricting stack access comprises storing a reference to a stack frame of a calling function before the call of the unsafe function.

3. The method according to claim 2, which comprises providing a mechanism preventing the called function from being able to access the value of the reference, the stack frame, and all data lying before that stack frame.

4. The method according to claim 1, which comprises providing a protective mechanism to ensure that the stack pointer does not go beyond the valid stack area of the called function.

5. The method according to claim 1, which comprises restoring the stack to an original state upon returning from an unsafe function.

6. The method according to claim 1, which comprises, in an event of a function call, initially reserving a memory area on the stack for function data to be protected, and thereafter optionally placing function arguments on the stack, and placing the reference, lying in the protected area, to the stack frame of the calling function on the previously reserved area of the stack, and writing the reference to the stack frame of the called function into the protected area.
